(19) United States
(12) Patent Application Publication
(10) Pub. No.: US 2009/0037269 A1
(43) Pub. Date: Feb. 5, 2009

(54) Integration of Cash Registers and WiFi Support for Customers

(76) Inventors: Richard T. Bassemir, Austin, TX (US); Ismael N. Castillo, Round Rock, TX (US); Forrest Blake Hilstrom, Austin, TX (US); Joseph S. Pu, Austin, TX (US); Artis L. Walker, Cedar Park, TX (US)

Correspondence Address: The Brevetto Law Group, PLLC, 838 Maine Street, Quincy, IL, 62301, US

(21) Appl. No.: 11/833,755

(22) Filed: Aug. 3, 2007

(51) Int. Cl. G06Q 30/00; G06Q 99/00

(52) U.S. Cl. 705/14; 705/1

(57) ABSTRACT

A WiFi sales reward system provides WiFi Internet access to customers in a store on a complementary basis along with purchases from the store. The store gives an Internet access code to the customer along with a qualifying purchase. The customer can then access the Internet through the store's WiFi hotspot by entering the access code when prompted for it. The access code grants a predetermined amount of Internet access time, based on the amount of the purchase or other terms specified by the store.

### BACKGROUND

1. Field

The present invention relates to Internet access, and more specifically, to systems, methods and computer products for providing Internet access to customers of a store.

2. Background

Business establishments sometimes offer wireless Internet access to customers and others within their store, or within reception distance of the store. For example, Internet cafes, coffee shops, hotels and other such business often offer free Internet access to those within reception distance, serving as WiFi hotspots for the local community.

However, such establishments cannot provide unlimited bandwidth for accessing the Internet. Their free Internet connections may get bogged down if too many customers, or non-customers, try to access bandwidth-intensive Internet content at the same time. Another problem arises when non-customers hang around the WiFi hot spots for extensive periods of time, taking up space within the store even though they may not be making any purchases. This may cause inconveniences to the store's paying customers, for example, a coffee shop customer who cannot find a seat due to non-paying Internet users hanging around the coffee shop.

Stores need a solution to distinguish between the store's customers seeking Internet access and others who want to use the store's Internet access without making any purchases.

### SUMMARY

Embodiments disclosed herein address the above stated needs by providing systems, methods and computer products for a WiFi sales reward system that grant Internet access to customers of the store who have made qualifying purchases.

Various embodiments disclosed herein grant Internet access via an Internet node of a store by providing an access code in association with a purchase. The WiFi sales reward system detects a customer seeking access to the store's wireless Internet node. In some embodiments the system provides a prompt requesting the customer to enter an access code. The WiFi sales reward system accepts entry of the access code, and in response to receiving the access code, the system grants access to the Internet through the store's WiFi Internet node. The store provides the access code to the customer as a complementary service in association with a purchase at the store.

Some embodiments associate access codes with customer accounts subject to replenishment for further purchases made at the store. The store may emboss the access code on a card given to the customer. The card may, in some embodiments, store value for purchasing items from the store.

### BRIEF DESCRIPTION OF THE DRAWINGS

The accompanying drawings constitute part of the specification, illustrating various embodiments of the invention. Together with the general description, the drawings serve to explain the principles of the invention. In the drawings:

FIG. 1 depicts activities involved in setting up and practicing the WiFi sales reward system;

FIG. 2 depicts a method of detecting a customer seeking wireless Internet access, and granting access to the customer in response to receiving an access code;

FIG. 3 depicts a method of monitoring a customer's Internet access once access has been granted;

FIG. 4 depicts a system suitable for practicing various embodiments of the WiFi sales reward system; and

FIG. 5 depicts details of a computer system suitable to implement the WiFi sales reward system.

### DETAILED DESCRIPTION

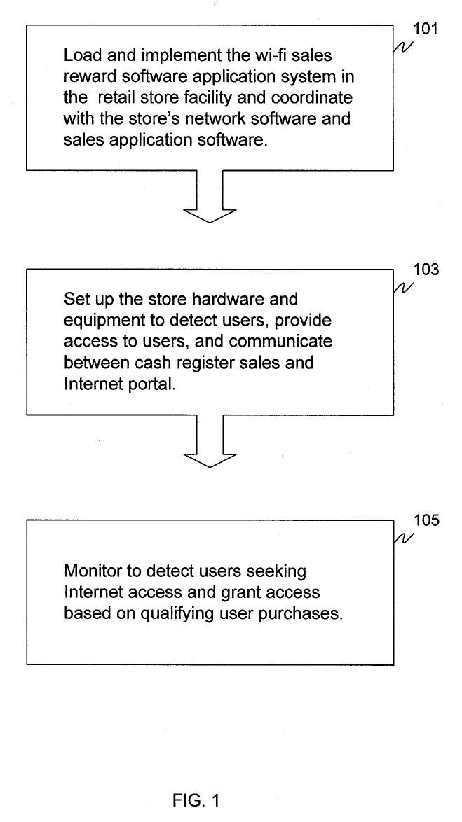

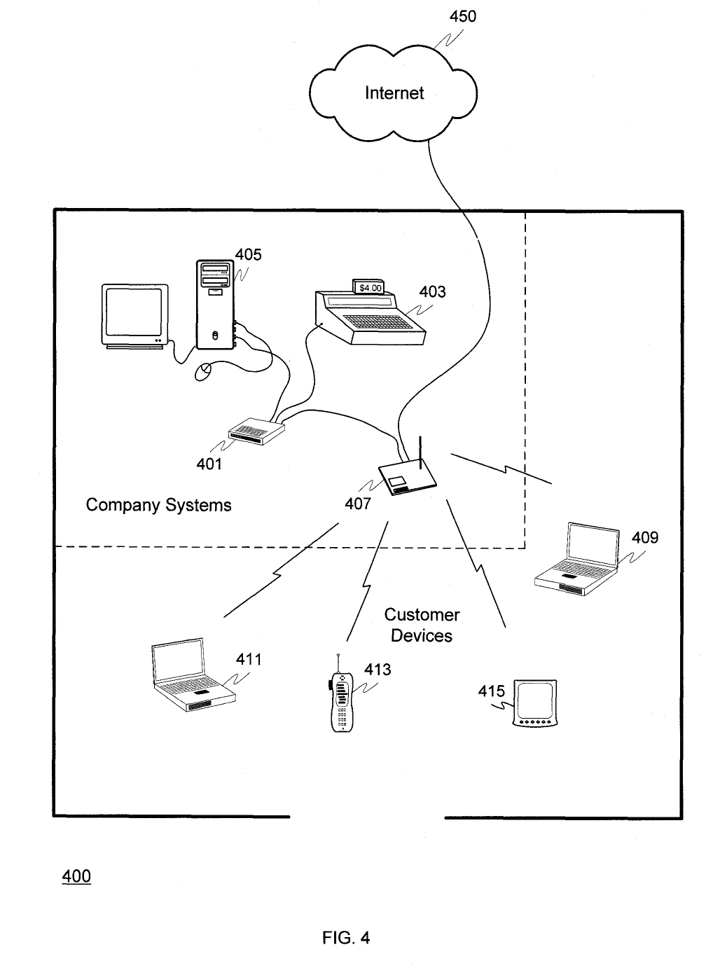

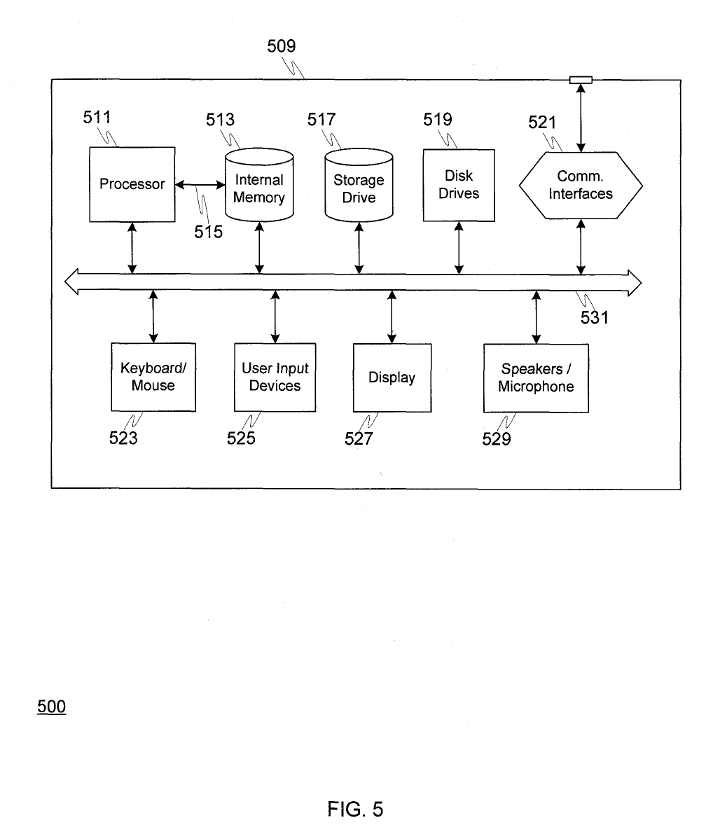

FIG. 1 depicts activities involved in setting up and practicing the WiFi sales reward system. Although this disclosure uses the term “WiFi”—an abbreviation of wireless fidelity—various embodiments may use any sort of wireless or wired Internet access. The activities of 101 include loading, setting up and implementing the WiFi sales reward system into the facilities and information technology (IT) system of the store. Setting up and implementing the WiFi sales reward system often involves loading and executing an application program or other software for the WiFi sales reward system on the store's servers or computer system. FIGS. 4-5 depict a typical computer system and network suitable for practicing the various embodiments. The store implementing the WiFi sales reward system application program or associated software may purchase it as a software product on machine readable media such as compact disks, floppy disks or other such storage media. Alternatively, the store may download the WiFi sales reward system from company selling it via the Internet as a software product to be implemented in the store.

Part of the system configuration in 101 involves setting up the WiFi sales reward system to communicate with the cash registers or other sales system of the store. This may be done by networking the computer which executes the WiFi sales reward system with the store's sales system (e.g., cash registers), or otherwise providing communication lines between the two systems. Alternatively, the store's sales system may issue access codes to consumers redeemable for Internet access time. The access codes may be encoded on cards issued by the store for this purpose, may be printed on slips of paper, may be communicated verbally by telling the customer an access code to be used, or may be communicated in any other like manner. In some embodiments the store may print access codes on the packaging of a good sold to the customer (e.g., printed on a coffee cup) or printed on the sales receipt for the good or service. The store's sales system may communicate with the WiFi sales reward system, so as to verify the access codes provided to customers. Alternatively, the WiFi sales reward system may use a prearranged set of access codes known by both the store's sales system and the controller for the WiFi node. Such a prearranged set of access codes may include either a list of access codes, or an algorithm for generating access code. If the access codes are known by both the store's sales system and the controller for the WiFi node, the controller for the WiFi node can verify an access code from a customer by checking it in a database before granting Internet access.

Upon loading the application software for the WiFi sales reward system and installing it in the store's computer system, the method proceeds from 101 to 103 to set up the hardware in the store to work with the system. One primary consideration of setting up the WiFi sales reward system entails providing Internet access for the store. The store's Internet bandwidth limits the Internet response time experienced by customers, and tends to increase the time required to download content. Therefore, stores typically find it desirable to have high speed Internet access. Further, the store should have WiFi antennas, wireless nodes, routers, or other like types of wireless or wired access ports configured to communicate with the customers accessing the Internet. For purposes of illustration, the disclosure describes various embodiments in terms of connecting to a WiFi hotspot or a wireless node. However, in practice the invention can be implemented using any sort of wireless or wired Internet connection. The WiFi sales reward system may provide wireless Internet access in any of several formats or protocols for wireless communications, including for example, any of the 802.11 standards or any other radiowave, infrared or other like type of wireless protocol known to those of ordinary skill in the art.

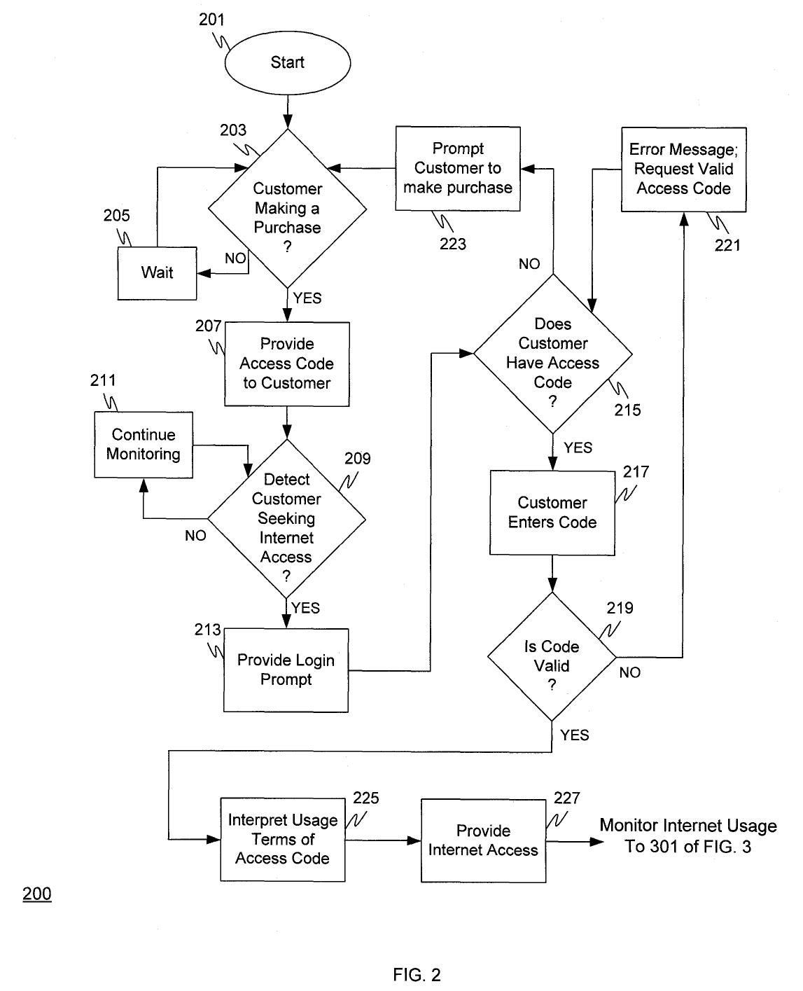

Another consideration in setting up the store's IT equipment and hardware involves the installation of a system for providing the access codes to the customers. A machine may be installed at the point of sale that embosses a card (or prints a slip of paper) with the access code. Alternatively, the store may simply keep a supply of cards with preprinted access codes for various predetermined amounts of Internet access already printed or stored on them (e.g., 15 minutes, 1 hour, 2 hours, etc.). In some embodiments the cards (or other access code devices) may themselves be able to communicate with the customer's computer to provide the access code to it. This may be done, for example, by providing a USB dongle or RFID card (radio frequency identification) instead of a printed card, or other like type of machine readable device for storing and communicating the access code. Once the store's IT equipment and hardware have been set up to provide Internet access to customers, the method proceeds from 103 to 105 to monitor and detect users seeking to access the Internet in the store. FIG. 2 and the accompanying text disclose further details about granting Internet access in accordance with various embodiments.

FIG. 2 depicts a method 200 for detecting a customer seeking wireless Internet access, and granting access to the customer in response to receiving an access code. The method begins in 201 and proceeds to 203 to detect a customer making a purchase. Until detecting a purchase, the method loops back around via 205 to continue waiting for a customer purchase. Upon detecting a purchase the method proceeds from 203 via the “YES” branch to 207 to provide an access code to the customer. In some embodiments the WiFi sales reward system may freely give out access codes along with every purchase. In other instances the cashier making the sale may ask customers whether they want a complementary access code, during the transaction for purchasing the item. In some other implementations, the WiFi sales reward system may provide an access code before the customer pays for the service (or good). For example, a customer may access the Internet using an access code provided by an automotive service station while the station repairs the customer's car. Typically, however, the customer only needs to pay for the good or service, and does not need to pay any additional amount to receive the access code. The store provides the access code for Internet access on a complementary basis in association with making a purchase. The purchase of the item serves as a condition precedent to receiving the access code, but the item need not have any relation to the Internet. Examples of such items unrelated to the Internet include a cup of coffee, a meal, or groceries, or may be a service or rental unrelated to the Internet such as washing a car, an airline ticket a movie rental, or the like.

Depending upon the particulars of the implementation, access codes may remain valid indefinitely, or they may expire after a predetermined period of time (e.g., expire after one week, or one hour, etc.). In some instances, the WiFi sales reward system may offer access codes along with every purchase, regardless of the amount of the sale or the nature of the item purchased. In other implementations the purchase must meet a certain dollar amount threshold to be a qualifying purchase entitled to receive an access code (e.g., purchases over $5.00 receive one hour of access time). The WiFi sales reward system may give out access codes for any and all purchases at the store, or may provide them only for the purchase of specified items. The WiFi sales reward system may give out access codes at any time during the day, or may give them out only during certain times of the day, e.g., during times that the store wants to attract customers. For example, a coffee shop experiencing slow sales during the afternoon and evening hours may offer Internet access codes during those slow periods as a way to attract customers. Alternatively, the coffee shop may offer complementary access codes during all hours, but provide greater benefits (e.g., increased access time) for the access codes given out during certain periods, such as the evening hours when sales are slow. Once the store has provided an access code to the customer, the method proceeds from 207 to 209.

Block 209 involves determining whether a customer has been detected seeking access to the Internet using the store's Internet node, e.g., the store's WiFi node. The WiFi sales reward system may detect a customer trying to establish a wireless connection with the store's WiFi hot spot. In some embodiments the WiFi sales reward system may recognize the customer's computer seeking access, either by recognizing the computer itself or recognizing the customer's account (if any) when an access code it entered. In such embodiments, the WiFi sales reward system may display personalized or tailored prompts on the customer's computer to greet the specific customer by name, and provide information the customer may find useful, based on the customer's demographics, past usage habits, or stated preferences. Returning to block 209, until detecting a customer, the method continues to loop back around from 209 to 211 via the “NO” branch, to continue monitoring for customers seeking Internet access. In response to detecting someone seeking Internet access, the method proceeds from 209 to 213 via the “YES” branch.

In 213 the system sends a login prompt to the customer. In other words, the WiFi node of the store sends signals to the customer's computer to display a screen that prompts the user for entry of an access code. The login prompt may say something like: “For Internet access at Java Joe's Coffee Shop, please enter your access code.” As discussed above, the WiFi sales reward system may provide an access code to a customer on a complementary basis at the time they make a purchase of goods or services in the store. The access code may be associated with a particular length of Internet access time, with the amount of access time being dependent upon the dollar value of the purchase, the type of items purchased, the time of day of the purchase, the time of day of the access, or any other variable associated with the sale or the access to the Internet. For example, a $4.00 purchase may entitle the customer to an access code providing 15 minutes of Internet access using the store's facilities. In another example, a coffee shop trying to develop regular customers may offer a special deal in which the coffee shop provides an hour's worth of Internet access for the purchase of a cup of coffee and a muffin. If the coffee shop has ample morning customers but lacks sales in the afternoon, it may offer greater quantities of Internet access time in the afternoon than it does in the morning, for comparable sales amounts.

Once the prompt has been provided to the customer in 213 requesting an access code, the method proceeds to 215 to determine whether the customer has a valid access code. If the customer (or other person seeking access) does not enter an access code, the method proceeds from 215 along the “NO” path to 223 to prompt the customer to make a purchase. For example, a person may see others in the store accessing the Internet, but the person does not know about the requirement to make a purchase to gain access. By providing a prompt in 223 the store can inform the person of the requirement for a purchase. (Alternatively, this may also be done as part of the prompt in 213). In 223 the store can also advertise any special sales that presently offered, in addition to prompting the person to make a purchase in order to qualify for Internet access. Once the person has been informed in 223 of the requirement to make a purchase, the method proceeds back to 203 to detect customers making a purchase. Returning to 215, if the customer has an access code the method proceeds from 215 along the “YES” path to 217 to receive entry of the code. Upon entering the code (e.g., by the user typing and entering an alphanumeric code known to the system) the method proceeds to 219.

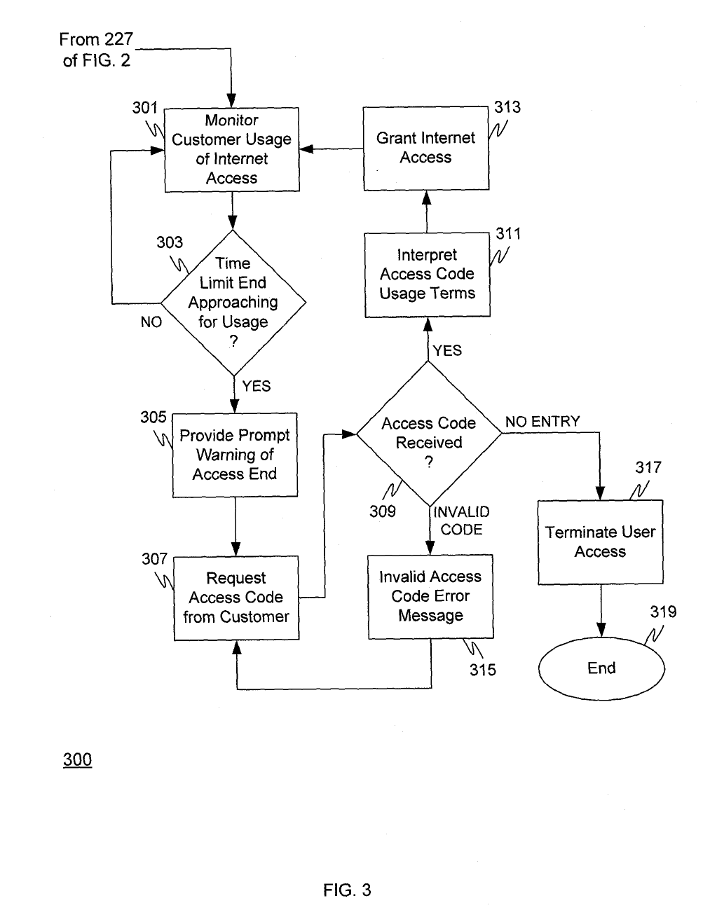

In 219 the WiFi sales reward system determines the validity of the entered access code. The code may be invalid because it expired, it may be invalid because the customer seeks to use it during a wrong time of the day (in implementations that require this), or because the customer entered it incorrectly, or the code may be invalid for any number of other reasons. If block 219 determines the access code to be invalid, the method proceeds from 219 to 221 along the “NO” path to provide an error message denying access to the customer, and requesting entry of a valid access code. The method then loops back from 221 to 215 to again determine whether the customer has a valid access code. Back in 219, once the WiFi sales reward system determines the access code to be valid and accepts entry of the access code (e.g., stores the access code, or otherwise enters it into the system), the WiFi sales reward system can begin the process of granting and monitoring Internet access. To do this the method then proceeds to 225 to interpret the terms of the access code. The activities in 225 entail determining what constraints or terms apply to the user's Internet access. For example, entry of the access code may entitle the customer to a certain amount of time for Internet access, or the WiFi sales reward system may restrict the access code for use only during a certain time of day or during predefined days of the week. The WiFi sales reward system may encode the usage terms on the customer's Internet access card, if any, or the terms may be associated with the access code entered by the user and known by the system. Once the usage terms associated with the access code have been interpreted in 225, the method proceeds to 227 to provide the customer with access to the Internet. After providing Internet access for the customer in 227 the method proceeds to 301 of FIG. 3 to monitor the user's Internet access.

FIG. 3 depicts a method of monitoring a customer's Internet access once access has been granted as per the activities described in conjunction with FIG. 2. The method begins in 301 by monitoring the Internet usage of a customer who has been granted access by the WiFi sales reward system. Monitoring the access in 301 does not necessarily imply reviewing the actual content being viewed or the sites visited. Monitoring the customer's Internet access entails measuring and tracking the amount of usage associated with the access code. Monitoring may involve keeping track of the time the user accesses the Internet using the WiFi sales reward system. In 303 the system monitors for an approaching end to the Internet access time limit associated with the access code within a predetermined time period (e.g., within 10 minutes, or one minute, or other like time). Until reaching the predetermined the time limit before the end of Internet access, the method loops back along the “NO” path to 301 to continue monitoring the customer's usage- Upon nearing the end of the predetermined access time limit in block 303, the method proceeds from 303 to 305 along the “YES” path.

In 305 the WiFi sales reward system provides a prompt warning the customer of the impending expiration of their Internet access. As soon as the customer's Internet access expires the method proceeds to 307 to request another access code. The prompts in 305 and 307 may be something along the lines of: “Your Internet access will expire in three minutes. Please enter another valid access code to extend your Internet session.” The method then proceeds to 309 to detect any valid access code entered by the customer. If the customer enters a valid access code the method proceeds to 311 to determine the terms of the access code. The terms of the access code may entitle the customer to a certain amount of Internet access time, or access during a certain time of day, etc. Once the usage terms associated with the access code have been interpreted in 311, the method proceeds to 313 to provide the customer with access to the Internet. The method then proceeds back to 301 to continue monitoring the customer's Internet usage time.

Returning to block 309, upon determining that the customer entered an invalid access code, the method proceeds to 315 along the “INVALID CODE” branch. In 315 the system provides a prompt to the customer informing them of the invalid access code. The method then proceeds back to 307 to request entry of a valid access code. Back in 309, once a predefined amount of time with receiving any access code from the customer, the method proceeds from 309 to 317 along the “NO ENTRY” branch, terminating the customer's Internet access. The method proceeds to 319 and ends.

FIG. 4 depicts an exemplary system suitable for practicing various embodiments of the WiFi sales reward system. Stores often set up a LAN or other such network so that the employees can access the company's computer applications, company data, or other information for business purposes. In some instances a router may be used to set up a wired LAN, and in other instances a wireless router may be used to provide a wireless LAN. FIG. 4 depicts a router 401 connecting the company's desktop computer 405 and cash register 403. Some embodiments store the application program for the WiFi sales reward system in a computer system at the company, for example, on a hard drive of the computer 405. Other embodiments store the WiFi sales reward system application program remotely, accessing it through communications lines or through the Internet. In yet other embodiments, the cash register 403, which itself may be a computer system, may store and execute the application program. FIG. 5 depicts further details of an exemplary computer suitable for executing the WiFi sales reward system application program.

A store providing wireless Internet access typically has one or more wireless nodes such as the wireless router 407. The wireless router 407 may connect to the Internet to provide Internet access to customers of the store. The embodiment illustrated in FIG. 4 shows the store's computer 405 connected to the wireless router 407 via the hardwired router 401 to provide Internet access for the store's computer. However, in some embodiments the store's computer 405 and cash register 403 may have separate connects to the Internet, or may be isolated without any Internet access, in order to ensure the security of the company's IT system.

FIG. 4 depicts the computer 405, router 401 and the wireless LAN 407 by way of example for the purposes of illustrating and explaining an exemplary information handling system of a store. In practice, the computers and network(s) of a company may in many different configurations, being interconnected either using a wired or wireless communications links, or some combination of these. In some instances, a company may employ stand-alone computers not interconnected by any sort of network or links, or a combination of networked computers and stand-alone computers.

The dotted line shown on FIG. 4 distinguishes the store's IT equipment and systems from the customer devices used to access the Internet in the store. A sampling of the types of devices used by customers for wirelessly accessing the Internet includes laptop computers 409-411, a cellular telephone 413 and a personal digital assistant (PDA) 415. These three devices illustrate the type of devices most commonly used to wirelessly access the Internet. Aside from the devices shown in FIG. 4, any device able to access WiFi or otherwise communicate wirelessly in accordance with wireless computer standards may practice various embodiments of the various embodiments.

FIG. 5 depicts block diagram details of an exemplary computer system 500 suitable for implementing various embodiments of the WiFi sales reward system. The block diagram 500 includes components often found in typical computer-type systems, such as the desktop computer 405, laptops 407-409, or cash register 403. A computer system 500 generally includes a processor 511 which may be embodied as a microprocessor or central processing unit (CPU). The processor 511 typically accesses an internal memory 513 via a bus such as the system bus 531. The internal memory 513 may include one or more types of memory, such as random access memory (RAM), read-only memory (ROM), cache memory, or a combination of these or other like types of circuitry configured to store information in a retrievable format. In some implementations the internal memory 513 may be configured as part of the processor 511, or alternatively, may be configured separate from it but within the same packaging. The processor 511 may be able to access internal memory 513 using control lines or a different bus such as local bus 515 than it uses to access the other components of computer system 509.

The computer system 500 also typically includes, or has access to, one or more storage drives 517 (or other types of storage memory) and floppy disk drives 519. The storage drive 517 may be a hard disk drive configured for the storage and retrieval of data, computer programs or other information. The floppy disk drives 519 may include a combination of several disc drives or optical storage drives of various formats that can read and/or write to removable storage media (e.g., CD-R, CD-RW, DVD, DVD-R, floppy disk, etc.). The computer system 500 may either include the storage drives 517 and floppy disk drives 519 as part of its architecture (e.g., within the same cabinet or enclosure and/or using the same power supply), may include these devices as connected peripherals, or may access the storage drives 517 and floppy disk drives 519 over a network, or a combination of these. The storage drive 517 often stores the software, instructions and programs executed by the computer system 500, including for example, all or parts of the computer application program for project management task prioritization.

J The computer system 500 may include communication interfaces 521 configured to be communicatively connected to the Internet, a local area network (LAN), a wide area network (WAN), or connect with other devices using protocols such as the Universal Serial Bus (USB), the High Performance Serial Bus IEEE-1394 and/or the high speed serial port (RS-232). The components of computer system 500 may be interconnected by a bus 531 and/or may include expansion slots conforming to any of various industry standards such as PCI (Peripheral Component Interconnect), ISA (Industry Standard Architecture), or EISA (enhanced ISA).

Typically, the computer system 500 includes one or more user input/output devices such as a keyboard and/or mouse 623, or other means of controlling the cursor (e.g., touchscreen, touchpad, joystick, trackball, etc.) represented by the user input devices 525. The computer system 500 generally includes a display 527. The display may be any of several types of displays, including a liquid crystal display (LCD), a cathode ray tube (CRT) monitor, a thin film transistor (TFT) array, or other type of display suitable for displaying information for the user. The display 627 may include one or more light emitting diode (LED) indicator lights, or other such display devices. In addition, most computer systems 500 also include, or are connected to, one or more speakers and microphones 529 for audio output and input. The WiFi sales reward system may use speech recognition software in conjunction with the microphones 529 to receive and interpret user speech commands.

The process of monitoring a customer's Internet access usage has been discussed above in terms of keeping track of the time a customer accesses the Internet. Other parameters for monitoring a user's Internet access may also be employed with various embodiments of the invention. For example, a customer's Internet usage may be based on the amount of downloads (or uploads) to the Internet. The WiFi sales reward system may measure a customer's Internet usage by keeping track of the bandwidth requirements for the customer's Internet activities. In another implementation the system may track the file sizes of files or other content downloaded (or uploaded) from the Internet. One other embodiment involves tracking the customer's keystrokes during their Internet access. The WiFi sales reward system may use other forms of measuring Internet usage known to those of ordinary skill in the art.

The present disclosure uses the term “customer” to describe those seeking access to a store's WiFi hotspot. In practice, a person may seek access with an access code received in conjunction with a purchase from another, affiliated store. The person may be considered a customer in the sense that they received a complementary access code by making a purchase at the affiliated store. In some implementations the customer seeking access may make a transaction, but not necessarily a purchase. For example, the “store” supplying the WiFi access may be a library, and the library's “customer” may be a library card holder. For Internet access sought from a WiFi node in an airport, the “customer” may be a ticket holder waiting at the airport.

Various activities may be included or excluded as described above, or performed in a different order, with the rest of the activities still remaining within the scope of at least one exemplary embodiment For example, in some embodiments block 303 and the associated blocks of FIG. 3 may be omitted so that the system provides no warning to the customer of their Internet access nearing the end. Instead, in such embodiments the flowchart of FIG. 3 proceeds directly to 315 to terminate the customer's access, and then prompt the customer for entry of another access code. The scope of the embodiments disclosed herein includes other such variations or omissions in the flowcharts.

The invention may be implemented with any sort of processing units, processors and controllers (e.g., the processor 511 of FIG. 5) capable of performing the stated functions and activities. For example, the processor 511 may be embodied as a microprocessor, microcontroller, DSP, RISC processor, or any other type of processor that one of ordinary skill would recognize as being capable of performing the functions described herein. A processing unit in accordance with at least one exemplary embodiment can operate computer software programs stored (embodied) on computer-readable medium such as the internal memory 513 or storage drive 517, e.g. hard disk CD, flash memory, ram, or other computer readable medium as recognized by those of ordinary skill in the art, or the computer software programs may be transmitted wirelessly to the processing unit.

The computer software programs can aid or perform the steps and activities described above. For example computer programs in accordance with at least one exemplary embodiment may include: source code for detecting a customer seeking access to the Internet; source code for accepting entry of a customer access code; source code for granting access to the Internet in response to receiving the access code; source code for providing the customer with an option to receive the access code as a complementary service in association with the purchase at said store; source code for providing a prompt requesting the customer access code; as well as source code for the other methods, activities and steps described herein.

The description of the various exemplary embodiments provided herein serves to illustrate rather than limit the invention, its application, or uses. Thus, the scope of the embodiments of the present invention encompasses variations that do not depart from the gist of the invention.

1. A method of granting Internet access via an Internet node of a store, the method comprising:
providing an access code in association with a purchase;
detecting a customer seeking access to the Internet via the Internet node of the store;
accepting entry of the access code; and
granting access to the Internet in response to the entry of the access code.

2. The method of claim 1, further comprising:
providing the access code as a complementary service in association with the purchase at said store.

3. The method of claim 1, wherein the Internet node of the store is a WiFi node.

4. The method of claim 1, further comprising:
providing a prompt requesting the customer to enter the access code.

5. The method of claim 4, further comprising:
customizing said prompt to the customer in response to recognizing a computer of the customer's seeking access to the Internet.

6. The method of claim 1, further comprising:
associating the access code with a customer account configured to be replenished in response to further purchases.

7. The method of claim 6, further comprising:
furnishing a card to the customer associated with the customer account.

8. The method of claim 7, further comprising:
configuring the card to also store value for purchasing items from the store.

9. The method of claim 8, wherein the items are unrelated to the Internet.

10. The method of claim 1, wherein the store is one of a plurality of associated stores at which the access code may be used to gain access to the Internet.

11. The method of claim 1, wherein the purchase is a first purchase, the method further comprising:
receiving a communication during the access granted by the store to make a second purchase associated with an increase in access time to the Internet.

12. A software product for granting Internet access via an Internet node of a store, the software product comprising a machine readable medium including a program of instructions, wherein the program of instructions upon being executed on a device causes the device to perform activities comprising:
providing an access code in association with a purchase;
detecting a customer seeking access to the Internet via the Internet node of the store;
accepting entry of the access code; and
granting access to the Internet in response to the entry of the access code.

13. The software product of claim 12, further causing the device to perform activities comprising:
providing the access code as a complementary service in association with the purchase at said store.

14. The software product of claim 12, further causing the device to perform activities comprising:
providing a prompt requesting the customer to enter the access code;
customizing said prompt to the customer in response to recognizing a computer of the customer's seeking access to the Internet

15. The software product of claim 12, the software product further causing the device to perform activities comprising:
associating the access code with a customer account configured to be replenished in response to further purchases;
furnishing a card to the customer associated with the customer account;
configuring the card to also store value for purchasing items from the store.

16. The software product of claim 12, wherein the purchase is a first purchase, the software product further causing the device to perform activities comprising:
receiving a communication during the access granted by the store to make a second purchase associated with an increase in access time to the Internet.

17. A system configured to be suitable for granting Internet access via an Internet node of a store, the system comprising:
an electronically readable storage medium that stores WiFi sales reward system application software programmed to provide an access code in association with a purchase;
detecting a customer seeking access to the Internet via the Internet node of the store; and
a processor configured to accept entry of the access code, and grant access to the Internet in response to receiving the access code.

18. The system of claim 17, wherein the access code is provided as a complementary service in association with the purchase at said store.

19. The system of claim 17, wherein the access code is associated with a customer account configured to be replenished in response to further purchases, the system further comprising:
furnishing a card to the customer associated with the customer account;
configuring the card to also store value for purchasing items from the store.
